(19) United States
(12) Patent Application Publication
(10) Pub. No.: US 2024/0106683 A1
(43) Pub. Date: Mar. 28, 2024

(54) CO-CHANNEL SIGNAL CLASSIFICATION USING DEEP LEARNING

(71) Applicant: A10 Systems Inc, Lowell, MA (US)

(72) Inventors: Bryan Crompton, Lowell, MA (US); Tanay Mehta, Plano, TX (US); Daniel Giger, Lowell, MA (US); Apurva N. Mody, Chelmsford, MA (US)

(73) Assignee: A10 Systems Inc, Lowell, MA (US)

(21) Appl. No.: 18/369,586

(22) Filed: Sep. 18, 2023

Related U.S. Application Data
(60) Provisional application No. 63/407,367, filed on Sep. 16, 2022.

(51) Int. Cl. H04L 25/02

(52) U.S. Cl. CPC H04L 25/0254

(57) ABSTRACT

One or more aspects of the present disclosure are directed methods, devices and computer-readable media for receiving, at a receiver, a signal, the signal including a cover signal and an embedded co-channel anomalous signal; performing, at the receiver, signal processing on the signal to determine one or more characteristics of the signal; inputting, at the receiver, the one or more characteristics into one or more trained neural networks; and receiving, as an output of the trained neural network, a classification of the signal, the classification identifying the cover signal and the embedded co-channel anomalous signal.

### STATEMENT REGARDING FEDERALLY SPONSORED RESEARCH OR DEVELOPMENT

This application was made with government support under Intelligence Advanced Research Projects Activity (IARPA) Contract No. 2021-21062400004. The U.S. Government has certain rights in this invention.

### CROSS REFERENCE TO RELATED APPLICATIONS

The present application claims priority to Provisional Application No. 68/407,367, filed Sep. 16, 2022, and entitled “CLASSIFICATION OF COCHANNEL SIGNALS USING CYCLOSTATIONARY SIGNAL PROCESSING AND DEEP LEARNING,” the entire content of which is hereby incorporated by reference.

### TECHNICAL FIELD

The subject matter of this disclosure generally relates to the field of wireless network operations and, more particularly, to signal classification in presence of co-channel interference, using deep learning techniques. This solution may also be referred to as the Detection and Characterization of Signals on Signals.

### BACKGROUND

Wireless broadband represents a critical component of economic growth, job creation, and global competitiveness because consumers are increasingly using wireless broadband services to assist them in their everyday lives. Demand for wireless broadband services and the network capacity associated with those services is surging, resulting in the development of a variety of systems and architectures that can meet this demand.

In a crowded airspace, where multiple different signals may be transmitted simultaneously over the same channel, separating desired signals at a receiver device from unwanted interfering signals is an ever-present challenge that needs to be addressed.

### SUMMARY

One or more aspects of the present disclosure are directed to identifying anomalous signals attempting to use an existing signal as cover or operating very close to such a cover signal (e. g., Snuggler). As will be described further, signal processing combined with machine learning techniques are proposed to classify a given signal and identify cochannel anomalous signals. The Power Spectral Density and Cyclostationary Signal Processing features of a captured signal are computed and fed into a neural network to produce a classification decision.

In one aspect, a method includes receiving, at a receiver, a signal, the signal including a cover signal and an embedded co-channel anomalous signal; performing, at the receiver, signal processing on the signal to determine one or more characteristics of the signal; inputting, at the receiver, the one or more characteristics into one or more trained neural networks; and receiving, as an output of the trained neural network, a classification of the signal, the classification identifying the cover signal and the embedded co-channel anomalous signal.

In another aspect, the one or more signal characteristics include a power spectral density of the signal, conjugate cycle frequencies of the signal, and non-conjugate cycle frequencies of the signal.

In another aspect, at least one of the one or more characteristics is inputted into the trained neural network.

In another aspect, all of the one or more characteristics are inputted into the trained neural network.

In another aspect, the method further includes performing multimodal fusion to combine outputs of at least two of the trained neural networks to determine the output. Fusion of the outputs from various neural networks may be carried out to improve the results.

In another aspect, the cover signal is one of a Long-Term Evolution (LTE), 3GPP 5G signal, Wi-Fi, Digital Video Broadcasting (DVB) or Advanced Television Systems Committee-Digital Television (ATSC-DTV) signals.

In another aspect, the co-channel anomalous signal is one of a Direct Sequence Spread Spectrum (DSSS) signal, a Single Carrier Signal using Binary Phase Shift Keying (BPSK), a Quadrature Phase Shift Keying (QPSK), a Quadrature Amplitude Shift Keying (QAM), Amplitude Phase Shift Keying (APSK) modulations, Chirp Modulated signal, a Frequency Modulated (FM) signal, a Frequency Shift Keying (FSK) signal, an Orthogonal Frequency Division Multiplexing (OFDM) signal, a Bursty signal, a Frequency Hopping Spread Spectrum Signal (FHSS), or a Gaussian Minimum Shift Keying (GMSK) signal.

In another aspect, the trained neural network is trained using a combination of over-the-air captured signals injected with synthetic co-channel anomalous signals.

In one aspect, a wireless network receiver includes one or more memories including computer-readable instructions and one or more processors. The one or more processors are configured to execute the computer-readable instructions to receive a signal, the signal including a cover signal and an embedded co-channel anomalous signal; perform signal processing on the signal to determine one or more characteristics of the signal; input the one or more characteristics into one or more trained neural networks; receive, as an output of the trained neural network, a classification of the signal, the classification identifying the cover signal and the embedded co-channel anomalous signal.

In one aspect, one or more non-transitory computer-readable media include computer-readable instructions, which when executed by one or more processors of a wireless network receiver, cause the wireless network receiver to receive a signal, the signal including a cover signal and an embedded co-channel anomalous signal; perform signal processing on the signal to determine one or more characteristics of the signal; input the one or more characteristics into one or more trained neural networks; and receive, as an output of the trained neural network, a classification of the signal, the classification identifying the cover signal and the embedded co-channel anomalous signal.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example environment in which wireless communications may take place according to some aspects of the present disclosure

FIG. 2 provides a visual depiction of a hybrid signal processing and machine learning methodology for signal classification according to some aspects of the present disclosure

FIG. 3 is a visual representation of a composite signal including a cover signal and a co-channel anomalous signal according to some aspects of the present disclosure

FIG. 4 shows representative Non-Conjugate and Conjugate Cycle Domain Profiles (CDP) of four example class types of signals according to some aspects of the present disclosure;

FIG. 5 illustrates parameter distribution for synthetic anomalies according to some aspects of the present disclosure;

FIG. 6 illustrates accuracy results of trained neural networks for signal classification according to some aspects of the present disclosure;

FIGS. 7A-C illustrate example architectures with multimodal fusion and associated accuracy results according to some aspects of the present disclosure;

FIG. 8 illustrates improvements in classifier accuracy according to some aspects of the present disclosure;

FIG. 9 illustrates accuracy results for persistent GMSK snuggler according to some aspects of the present disclosure;

FIG. 10 illustrates an example neural network that can be trained to perform interference signal detection and classification, and/or interference mitigation scheme according to some aspects of the present disclosure;

FIG. 11 is an example flowchart of a method of signal classification according to some aspects of the present disclosure; and

FIG. 12 illustrates an example computing system according to some aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

As noted above, in a crowded airspace, where multiple different signals may be transmitted simultaneously over the same channel (or over a finite and limited available bandwidth), separating desired signals at a receiver device from unwanted interfering signals is an ever-present challenge that needs to be addressed.

Anomalous co-channel signals may attempt to use an existing signal (an intended or desired signal) as cover. There are at least two ways this can be done. One approach is to transmit the anomalous signal at a lower power within the entire band of the cover signal and deal with the interference from the cover signal by using spreading. Another approach is to transmit a narrowband signal, termed as a “snuggler”, positioned in frequency at the edge of the cover signal's spectral occupancy. The logic behind this is that low resolution energy detection methods will not easily identify the presence of such as a signal as the anomalous signal appears to merge into the cover signal.

Cover signals can be signals including, but not limited to, Long Term Evolution (LIE) signals, Advanced Television Systems Committee-Digital Television (ATSC-DTV) signals, etc. These signals may be continuously transmitted at known frequencies in a given geographical location. An underlay signal (e.g., an anomalous signal) can be a Direct Sequence Spread Spectrum (DSSS) signal with many choices for Phase-Shift Keying/Quadrature Amplitude (PSK/QAM) modulation, pulse shaped filters, and spreading sequences. The underlay signal remains cochannel with the cover signal and occupy a significant proportion of the bandwidth of the cover signal. A snuggler signal can be any narrowband signal with a modulation such as PSK/QAM or Gaussian Minimum Shift Keying (GMSK) modulation, but with a bandwidth that is a significant fraction of the cover signal. The underlay signal may be positioned as close as possible to the cover signal such that any spectral leakage does not cause performance reducing interference to the snuggler signal.

As will be described below, one or more aspects of the present disclosure are directed to identifying, for a given, known, cover signal, presence of an anomalous signal and a type thereof (e.g., an underlay/DSSS signal, a snuggler, a narrowband signal, etc.).

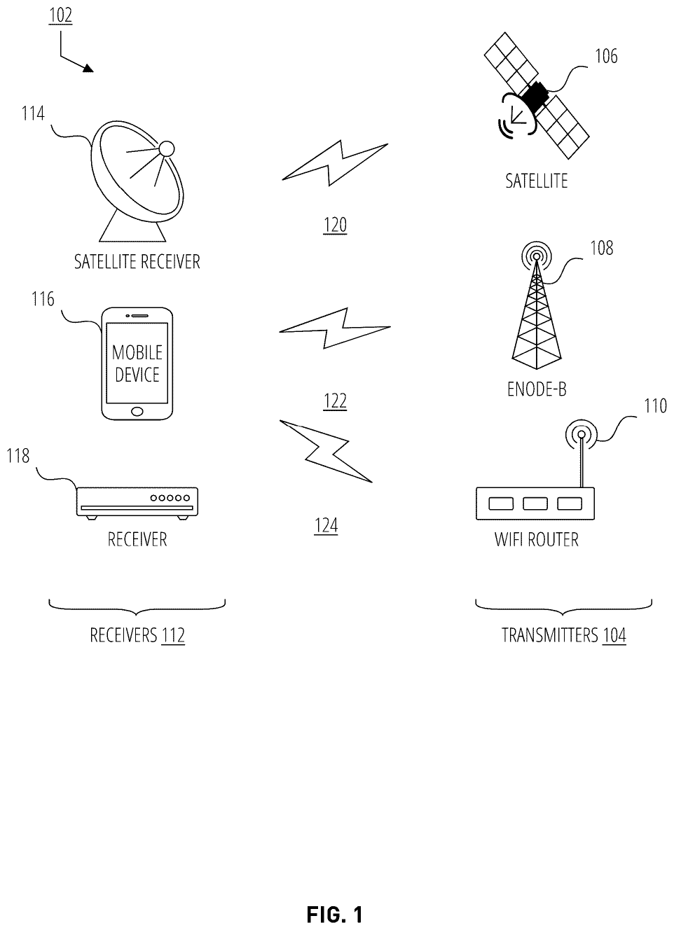

FIG. 1 illustrates an example environment in which wireless communications may take place according to some aspects of the present disclosure. Non-limiting example environment 102 can be any medium or environment in which terrestrial and/or extraterrestrial wireless communications may take place. The type of wireless communications can include, but are not limited to, satellite or radar communications, cellular-technology based wireless communications (e.g., 4G, LTE, 5G, etc.), known-or to be developed WiFi-based communications, etc. As may be known, any one-off known or to be developed types of wireless communication may utilize licensed and/or unlicensed bands for transmission and reception of Signals. Each wireless communication scheme may operate according to relevant standards established and agreed upon for such wireless communication scheme (e.g., IEEE 802.11x standards for WiFi).

Available frequency spectrum for wireless communications does not grow linearly with the ever-increasing number of devices and systems that communicate using wireless communication schemes. Accordingly, as spectrum availability becomes scarce and more limited, multi-system or multi-user communication where a given frequency band and channel are used to simultaneously transmit multiple Signals (Signals operating based on the same or different types of communication schemes).

For instance, in environment 102 of FIG. 1, multiple example wireless communication systems may operate. Different types of transmitters (grouped as transmitters 104) may exist. Transmitters 104 may include Satellite 106, eNode-B 108, and WiFi Router 110. The number and types of transmitters 104 are not limited to that shown in FIG. 1. There can be more than one of each of type of transmitter shown as part of transmitters 104 (e.g., more than one Satellite 106, more than one eNode-B 108, more than one WiFi Router 110, etc.).

Environment 100 may further include Receivers 112. Receivers 112 may include a Satellite receiver 114 that can send or receive radar signals from to and from satellite 106. Receivers 112 may further include Mobile Device 116, Receiver 118, etc., each of which may be capable of receiving and/or transmitting wireless signals according to any one or more wireless communication protocols. The types and numbers of receivers are not limited to those shown in FIG. 1 and can include any number of the same type of receivers shown and/or any other type of known or to be developed equipment capable of sending and receiving wireless Signals.

Any one of example Receivers 112 may be configured to operate based on more than one type of wireless communication scheme. For instance, Mobile Device 116 can operate using cellular technology and WiFi technology, Receiver 118 may be capable of operating based on radar technology, cellular technology, and/or WiFi technology.

Various transmitted wireless Signals transmitted in environment 102 by any one of transmitters 104 for reception by an intended one(s) of Receivers 112 are shown as example Signals 120, 122, and 124.

In one example, any one of transmitters 104 can also operate as a receiver and similarly any one of Receivers 112 can operate as a transmitter.

As noted above, with the frequency spectrum becoming more limited and scarcer due to increase in demand, a single frequency channel may be utilized by more than one system for signal transmission and hence result in simultaneous use of the channel that can lead to Multi-User Interference (MUI). Various techniques have been introduced to avoid MUI (e.g., channel sniffing to determine whether a particular frequency channel is available for use and if not, implementing random back-offs until a channel becomes available).

In wireless communications, signal classification is challenging problem, which at its heart, involves mapping a vector of captured quadrature (IQ) data to a label. Methods to do this include both statistical signal processing and machine learning techniques.

Signal processing techniques, such as Cyclostationary Signal Processing (CSP), work well for signal classification when conditions allow for good statistical estimation and the number of signals, and their complexity is low. CSP takes a high dimensional IQ vector and maps it to a lower dimensional set of CSP features which includes Cycle Frequencies (CFs) and Spectral Correlation and Spectral Coherence values. These CSP features are then interpreted in some manner to assign a signal type label. A different, common Machine Learning approach to classify signals is to use raw IQ data and pass it through a neural network such as a Convolutional Neural Network (CNN), trained on a prior data.

Aspects of the present disclosure propose a hybrid signal processing and machine learning methodology to signal classification by computing cyclostationary signal processing features and using them as inputs to a trained neural network architecture instead of raw IQ data.

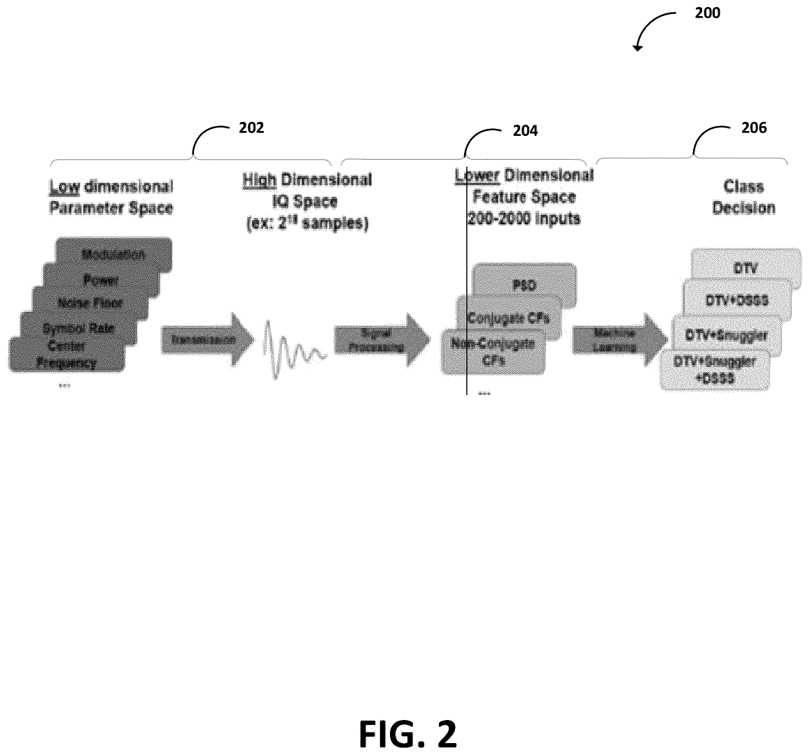

FIG. 2 provides a visual depiction of a hybrid signal processing and machine learning methodology for signal classification according to some aspects of the present disclosure.

In one aspect, the underlying parameter space of signals being considering is lower than the dimension of the captured IQ space, which allows for preserving much of the relevant parameter information while at the same time reducing the dimensional size of a feature space through Power Spectral Density (PSD) and CSP processing.

Flow 200 includes several stages for creating a hybrid signal processing and machine learning solution for signal classification. Stage 202 is dataset creation stage. In stage 202, a dataset of IQ files may be created using both captured signals and synthetic signals controlled by an underlying parameterization (e.g., modulation, power, noise floor, symbol rate, center frequency, etc.). Then, a high dimensional IQ space of a given length N may be produced. The dataset may be transmitted and received at a radio receiver (e.g., one of receivers 112). At stage 204, signal processing techniques may be applied to create a lower dimensional feature space. This lower dimensional feature space may be created by calculating the PSD with a configurable frequency resolution resulting in M points in frequency space, with M<<N. A non-conjugate and conjugate (CSP) Features (CFs) may then be calculated. At stage 206, PSD and the conjugate and non-conjugate CFs may then be fed into a trained neural network (e.g., a neural network with fully connected layers), the output of which can provide a classification decision (signal classification) classifying a signal as DTV, DTV+DSSS, DTV+snuggler (GMSK), DTV+DSSS+Snuggler (GMSK), etc.

Dataset creation at stage 202 may be as follows. A combination of Over the Air (OTA) captured ATSC-DTV signals may be used. These signals may be normalized to unit power and then divided into a preassigned block size of length 2′. Synthetic signals (e.g., representative of an anomalous signal) may be generated using GNU Radio functions. One example GNU radio function may be used to generate a DSSS signal with variable chip rate, center frequency, and power, and another GNU radio function may be used to generate a GMSK signal with variable symbol rate, center frequency and power. ATSC-DTV signals and synthetic signals may be combined, according to selected parameter choices, to create a composite signal. The composite signal may be represented as:

S(t)=SDTV(t)+SDSSS(t,α˜DSSS)+SGMSK(t,α˜GMSK)+N(t) (1)

In equation (1), SDTV is the normalized OTA ATSC-DTV signal, SDSSS is the DSSS signal controlled by parameters α˜DSSS, SGMSK is the GMSK signal with controllable parameters α˜GMSK, and N is a controllable noise signal.

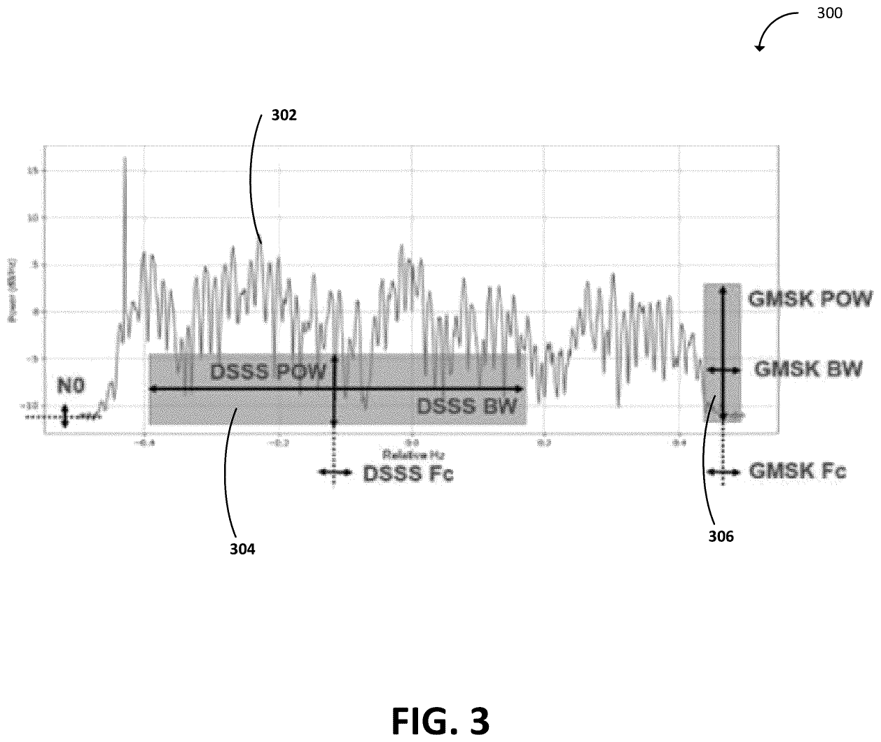

FIG. 3 is a visual representation of a composite signal including a cover signal and a co-channel anomalous signal according to some aspects of the present disclosure. Signal 300 of FIG. 3 is a non-limiting example of signal S(t) of equation (1) in frequency domain. In creating the composite signal, there are 7 controllable parameters including, noise power, DSSS power, DSSS bandwidth, DSSS center frequency, GMSK power, GMSK bandwidth, and GMSK center frequency. By setting the power of either, or both, of the DSSS and GMSK signals, four classes of signals, namely, DTV, DTV+DSSS, DTV+GMSK, and DTV+DSSS+GMSK may be crated.

Signal 302 of FIG. 3 illustrates power of a cover signal (e.g., ATSC-DTV signal) over frequency with lower power anomalous signal 304 and snuggler signal 306 at the edge of the cover signal's spectral occupancy.

Signal processing of stage 204 may be as follows. With dataset of IQ datafiles created as stage 202, signal processing may be applied to each file to produce features for to be used as input into a neural network for signal classification. Initially, the PSD of signal S(t) may be determined using, for example, Welch's method with some chosen frequency resolution Af resulting in M PSD points. Next, a list of CSP 4-tuples of the form below may be created:

(f*,a*,s*,c*).

For a cyclostationary stochastic process x(t), the spectral correlation is defined as:

Sₓ^{α}(f)=∫_{-∞}^{∞}Rₓ^{α}(τ)e^{-i2πfv}dτ(2)

where Rax(τ) is the cyclic autocorrelation function of the stochastic process x(t). Additionally, another related function is the Spectral Coherence Function (Coh), which is defined using the SCF as:

$${C}_{x}^{a} ( f ) = \frac{{S}_{x}^{a} ( f )}{\sqrt{{S}_{x}^{0} ( f + α / 2 ) ( {S}_{x}^{0} ( f - α / 2 ) )}} , \qquad ( 3 )$$

which has the property that's modulus is always less than or equal to one.

One of the defining characteristics of a cyclostationary stochastic process is that the spectral correlation is non-zero only for a set of a values known as Cycle Frequencies (CFs). For a given CF α*, f*=argmax_{f}sₓ^{=α}′(f), s^{s}m′max_{f} s′ₓ^{a=a*}(f), and C^{x}=max Cₓ^{a=a*}(f). This produces a CSP 4-tuple as discussed above.

For all of the above, these functions are known as the Non-Conjugate (NC) versions of the SCF and Coh. There are companion second order cyclostationary functions known as the Conjugate (C) Spectral Correlation Function and the Conjugate (C) Spectral Coherence Function. These functions have similar properties as the non-conjugate version.

For a realized cyclostationary stochastic process, which is many communications signals, the SCF and the CFs may be estimated using, for example, the Strip Spectral Correlation Analyzer (SSCA). From this, a finite list of CSP 4-tuples, one list of non-Conjugate values and another list of Conjugate values may be determined that may not necessarily have the same length.

In one example, after obtaining these 4-tuple matrices, the 4-tuples may be ordered by the third element, i.e., the Coherence. The reason is that a large coherence represents a more significant Cycle Frequency. Then, given that the list of 4-tuples can potentially be any size, the L most significant 4-tuples may be selected based on significance, as measured by the coherence.

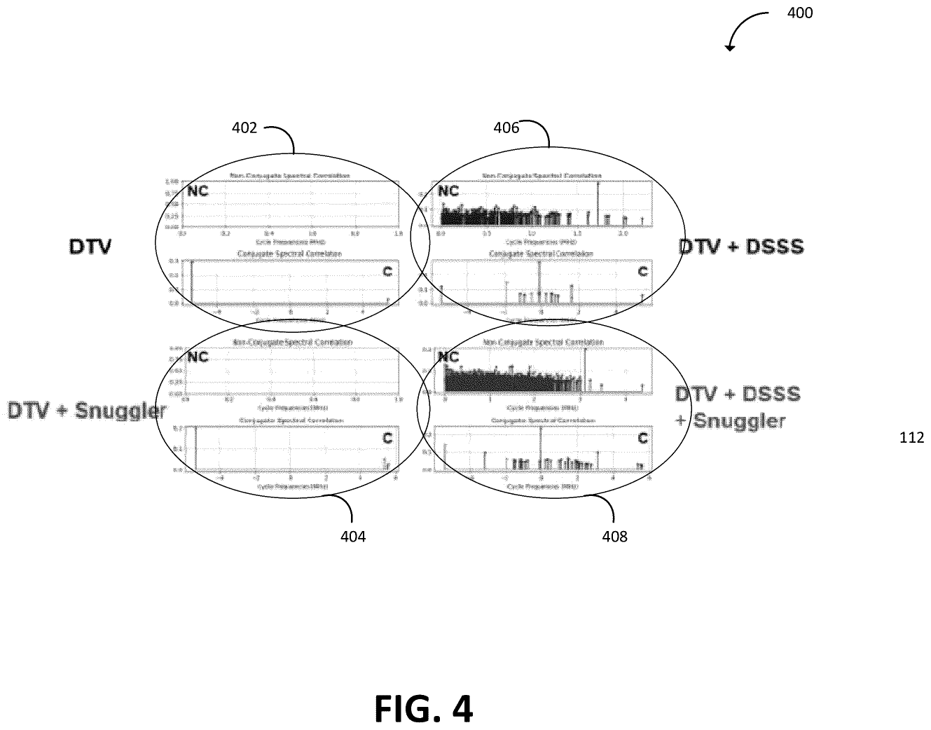

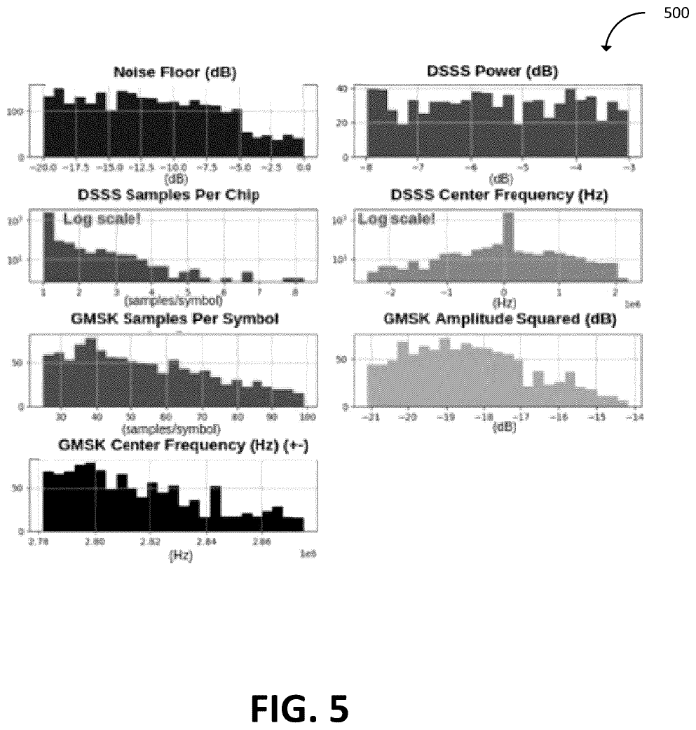

One approach to visualize CSP features is using a Cyclic Domain Profile (CDP) which plots either the SCF or Coh as a function of the CFs. FIG. 4 shows representative Cyclic Domain Profiles of four example class types of signals according to some aspects of the present disclosure. In plot 400, CDPs (NC and C versions of the SCF) of each of the four class types, DTV, DTV+DSSS, DTV+GMSK, and DTV+DSSS+GMSK. DTV are shown that have a small number of CFs in the C domain, and no CFs in the NC domain. In plots 402, DTV has no CFs in the NC domain and a small number of CFs in the C domain. Plot 404 shows that GMSK (snuggler), when combined with DTV has no CFs in the NC domain and a small number of CFs in the NC. DSSS is known to have a lot of CFs in both the NC and C domains. In the cases of DTV+DSSS and DTV+DSSS+GMSK, this is evident as shown in plots 406 and 408. However, in the case of DTV+DSSS+GMSK, the classification problem can be thought of as attempting to locate the “needle” of GMSK CFs in the “haystack” of the DSSS CFs.

With stage 202 (dataset creation) and stage 204 (signal processing) completed, stage 206 (neural network training and machine learning) will be described next.

In some examples, two types of architectures on both individual and joint CSP and PSD inputs may be utilized. However, the present disclosure is not limited to just these two types of architectures and other architectures may be used as well. The first type may use only one form of input feature while the second type may be a fusion model that takes both features as input. In another example, an augmentation to these models using self-attention to improve training time and find the location of the anomaly in the input may also be utilized.

In these architectures, C may be the number classes characterizing the input signal. Let n be the dimension of the input. The individual model is the parameterized function class fθ:Rn−+Rc. For x E Rn, we define fθ(x)=z such that:

z=softmax(W₃L₂(L₁(x))),W₃∈ [symbol] ^{G4xe}

Lᵢ(x)=ReLU(LayerNormᵢ(Wᵢz);γᵢ,βᵢ),for i∈[2],Wᵢ∈ [symbol] ^{a}^{ᵢ}^{×b}^{ᵢ};z,γᵢ,βᵢ∈ [symbol] ^{k}^{ᵢ}

where a1=n, b1, a2=128, b2=64, k1=n, k2=a2. ReLU denotes the standard rectified linear unit function (ReLU(x)=0 if x<0; x if x>0), and LayerNormi is a layer normalization defined for z E Rk as:

$${LayerNorm}_{i} ( z ; {γ}_{i} , {β}_{i} ) = γ \frac{z - {μ}_{z}}{{σ}_{z}} ,$$

$$where$$

$${μ}_{z} = \frac{1}{k} {\sum }_{j = 1}^{k} {z}_{j} , {σ}_{z} = \sqrt{\frac{1}{k} {\sum }_{j = 1}^{k} {( {z}_{j} - {μ}_{z} )}^{2}} .$$

$${γ}_{i} , {β}_{i} ∈ {ℝ}^{k}$$

The softmax function normalizes the input into a probability vectors as:

$$softmax ( z ) = \frac{exp ( z )}{{\sum }_{j = 1}^{k} {z}_{j}} .$$

The parameters θ of the model consist of the weight matrices Wi as well as the LayerNorm parameters γi,βi. The input vector x to the model can be thought of as representing either the PSD features of the signal or the CSP features. In the case of the latter, the input may be flattened to a single dimension as the CSP features are represented as an m×4 matrix where each row contains a single 4-dimensional FACS cyclostationary feature.

Thus, the above architecture gives rise to two separate deep learning models: the first type that takes PSD features as input, and a second type that takes CSP features. However, another model may be a feature fusion model that takes as input both PSD and CSP features. In this fusion model, the input as the concatenation of the PSD×E Rn and CSP y E Rn′ features (x, y):

z=softmax(WL(concat(P(x),C(y)))),W∈ [symbol] ^{G4xe}

L(z)=ReLU(LayerNorm(W′z);γ,β),W′∈ [symbol] ^{a×b};z,γ,β∈ [symbol] ^{k}

P(x)=L₂(L₁(x)),C(y)=L₄(L₃(y))

Lᵢ(z)=ReLU(LayerNormᵢ(Wᵢz);γᵢ,βᵢ),for i∈[4],Wᵢ∈ [symbol] ^{a}^{ᵢ}^{×b}^{ᵢ};z,γᵢ,βᵢ∈ [symbol] ^{k}^{ᵢ}

where a1=n, b1, a2=128, b2=64, k1=n, k2=a2, and a3=n′, b3, a4=128, b4=64, k3=n′, k4=a4.

In some aspects and in order to not only identify an anomaly but also specifying where in the cover signal the anomaly is, the above models may be modified by applying a multi-head self-attention layer to the input vector before proceeding as above for each architecture. For x E Rn,

$$z = softmax ( {W}_{3} {L}_{2} ( {L}_{1} ( MultiHeadAttn ( x ) ) ) )$$

$$MultiHeadAttn ( x ) = concat ( {head}_{1} ( x ) , … , {head}_{h} ( x ) )$$

$${head}_{i} ( x ) = softmax ( \frac{( {Q}_{i} x ) {( {K}_{i} x )}^{T}}{\sqrt{k}} ) {V}_{i} x ,$$

$${Q}_{i} , {K}_{i} , {V}_{i} ∈ {ℝ}^{n \times k} .$$

where W3 and Li are as above. Similarly, replace each input component x and y with MultiHeadAttn(x) and MultiHeadAttn(y) for the joint model.

For training any of the above-described neural network architectures, the above-described IQ dataset may be generated by taking over-the-air captures of ATSC-DTV signals, and then injecting various anomalies into these captures. In a non-limiting example, using a SignalHound, 10 captures of 100 ms at 575 Mhz with 61.44 Mhz sampling producing 6 usable signals of ATSC-DTV at 6.25 Mhz may be taken. These signals may then be broken down into blocks of length 2¹⁸. The input DTV and output composite signals may both normalized to unit power. The number of signals, the duration and frequencies at which they are taken, and the size of the blocks are not limited to these examples and may vary based on experiments and/or empirical studies.

As also described above, two non-limiting example classes of anomalies may be injected artificially on the above captured signals using GNU Radio. These two non-limiting example anomalies may be DSSS with gain 1k and GMSK with BT=0.35. These anomalies are inserted by randomly sampling parameters described above (e.g., modulation, power, noise floor, symbol rate, center frequency, etc.). For DSSS and GMSK, power, bandwidth, frequency center as well as the noise floor may be used. Parameters were biased for DSSS with full bandwidth. DSSS and GMSK center frequencies were selected depending on their bandwidths. In one example, these parameters are slightly pushed beyond expected realistic scenarios to improve neural network performance.

FIG. 5 illustrates parameter distribution for synthetic anomalies according to some aspects of the present disclosure. Plots 500 show various parameters (e.g., PSD) distribution for different anomalous signals.

The PSD may be calculated using Welch's method for 1024 points. The SSCA may be determined on block lengths of 218 and 64 channels. However, the method and associated parameters used for PSD calculation are not limited to these examples and may be altered according to experiments and/or empirical studies.

In total and in one non-limiting example, the final dataset comprised of around 1000 ATSC-DTV signals approximately evenly split across classes: DTV, DTV+DSSS, DTV+Snuggler, DTV+DSSS+Snuggler. The neural networks may be trained for 40 epochs at 6 sec per epoch with Intel Xenon 623OR CPU (2.10 GHz) and NVIDIA RTX A5000 (24 GB memory).

Next, results of training signal classification neural networks described above is provided.

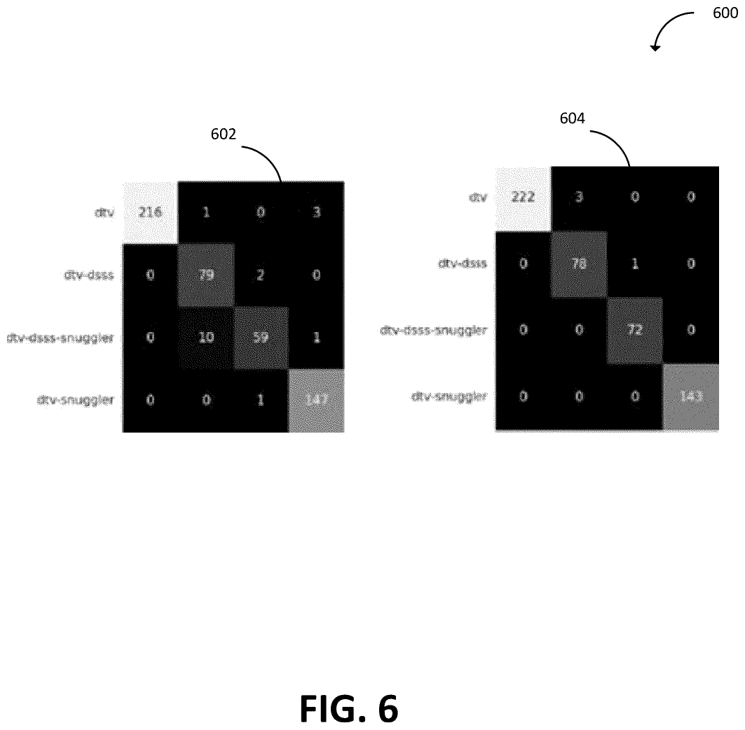

The performance of the CSP-only model trained is analyzed and tested on a dataset with realistic anomaly parameters. FIG. 6 illustrates accuracy results of trained neural networks for signal classification according to some aspects of the present disclosure. As shown in tables 600, the CSP-only model (table 602) achieves 96% accuracy, but the joint model (table 604) improves the accuracy to 99%. Furthermore, to understand better the generalization of the model, more difficult dataset has been considered with much more aggressive DSSS anomaly parameters.

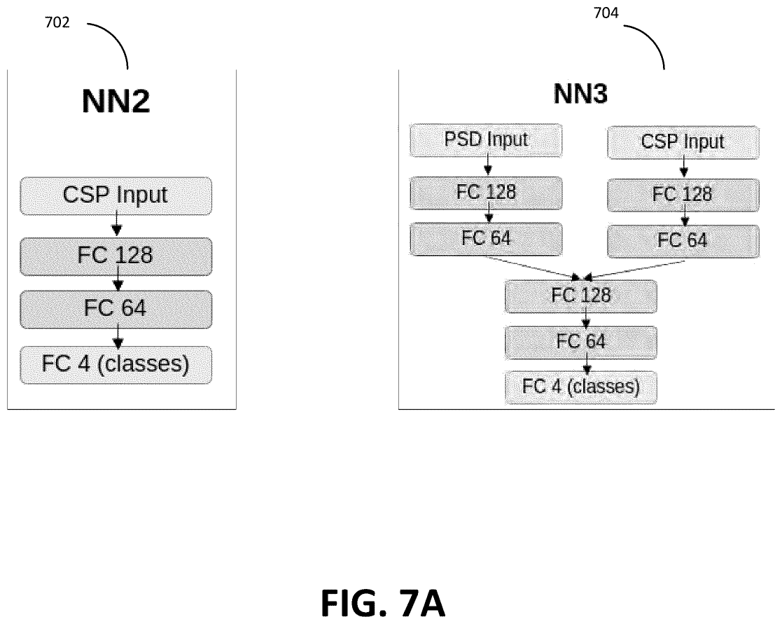

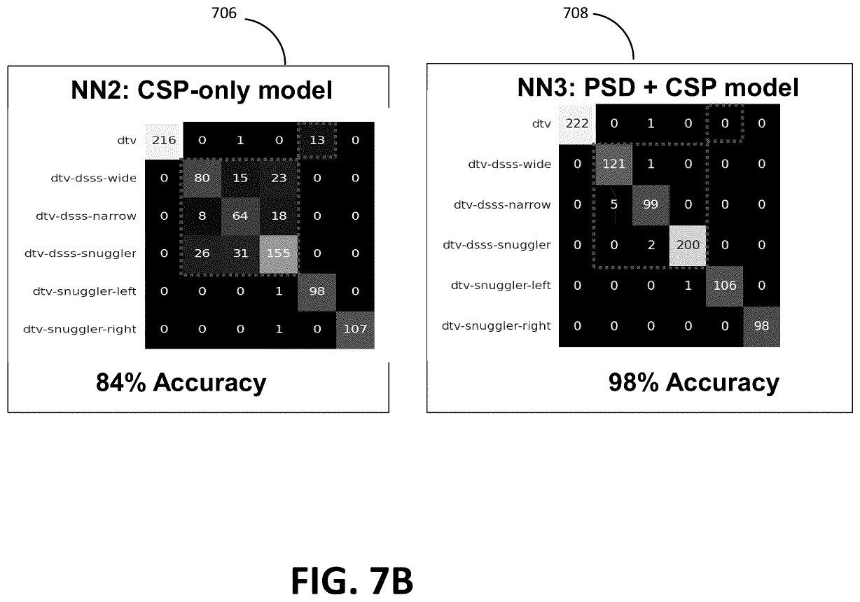

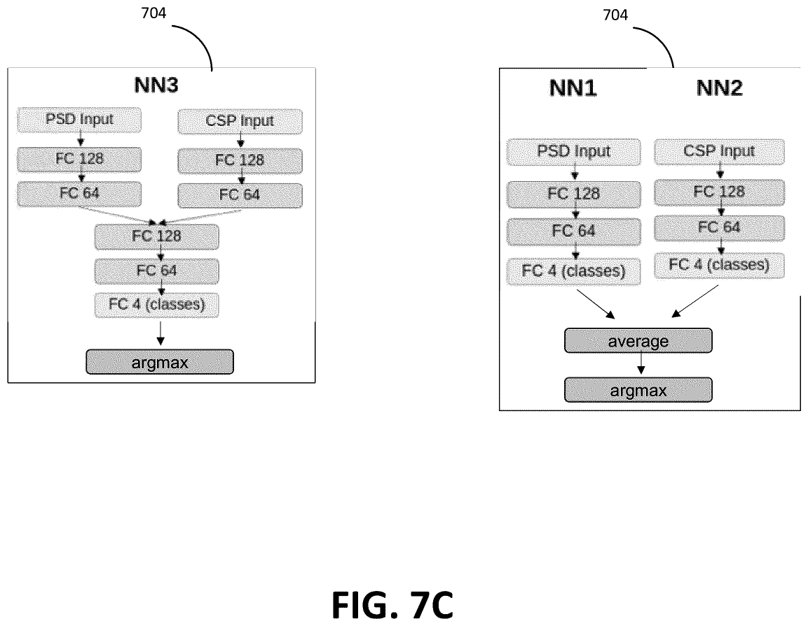

FIGS. 7A-C illustrate example architectures with multimodal fusion and associated accuracy results according to some aspects of the present disclosure. Model 702 of FIG. 7A illustrates a CSP-only neural network architecture according to one non-limiting example with fully connected layers (FC) 128 and 64, trained to identify four signal classes (FC 4). Table 706 in FIG. 7B illustrates the accuracy results of the CSP-only model. As shown, the CSP-only model achieves 84% accuracy.

Model 704 of FIG. 7A illustrates a joint CSP-PSD neural network architecture according to one non-limiting example where each of the PSD and CSP portions of the joint model have 128 and 64 fully connected layers as shown, combined into another 128 and 64 fully connected layers trained to ultimately identify four signal classes. Table 708 in FIG. 7B illustrates the accuracy results of the join PSD-CSP model. As shown, but the joint model boosts the accuracy to a near-perfect 98%. However, the models can further distinguish between varying types of the same anomaly. In particular, the classifiers can distinguish between the presence of a snuggler on the left or right of the center frequency as well as large and small bandwidth of DSSS anomalies. The term classifier may be used interchangeably with the term trained neural network and/or trained machine learning model.

FIG. 7C provides non-limiting examples of neural network architectures for fusing outputs of join PSD-CSP models. In example architecture 710 of FIG. 7C example approach of feature concatenation may be utilized while in example architecture 712 of FIG. 7C last layer softmax averaging as described above with reference to described mathematical formulas, may be utilized. While feature concatenation and last layer softmax averaging are mentioned, the present disclosure is not limited thereto and other known or to be developed approaches for multi-model feature fusion may be used instead and/or in combination with one another.

Example neural network architectures that may be utilized for CSP and/or joint PSD-CSP models can include convolutional neural networks (CNN), any other neural or deep learning network, such as an autoencoder, a deep belief nets (DBNs), a recurrent neural networks (RNNs), etc.

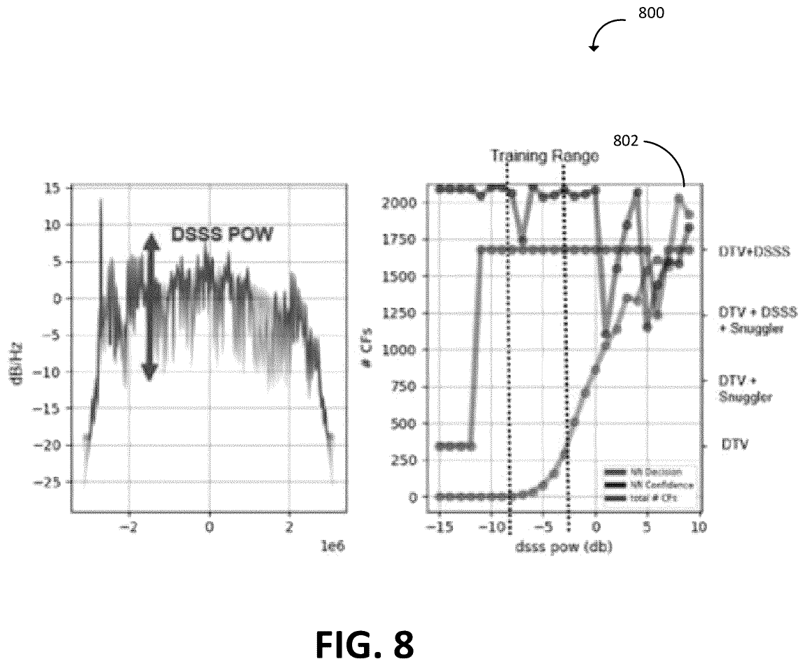

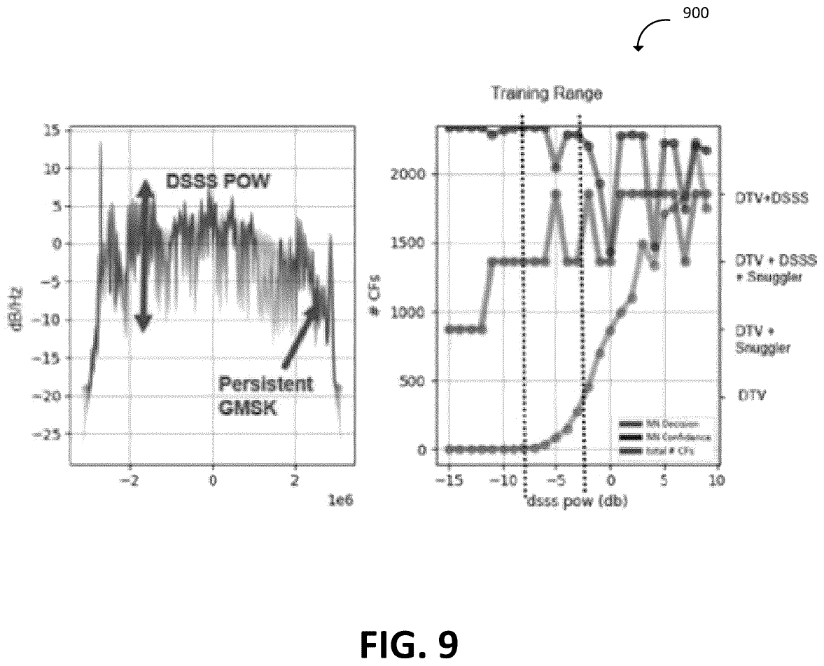

In order to test generalization of these models, further accuracy tests have been performed of the CSP-only classifier on a series of ATSC-DTV signal files injected with varying amounts of DSSS power. FIG. 8 illustrates improvements in classifier accuracy according to some aspects of the present disclosure. Plots 800 show continued improvements in accuracy and continues to give the correct answer well outside of the model's training range, especially on the right side (plot 802). FIG. 9 illustrates accuracy results for persistent GMSK snuggler according to some aspects of the present disclosure. As shown in plots 900, an experiment is repeated with a persistent GMSK snuggler. In this case, the classifier is slightly less effective as the DSSS anomaly eventually is too powerful and the classifier loses sight of the snuggler.

In the above example embodiments described above, the trained neural network (a classifier) determines a particular type of anomaly in a cover signal (e.g., DSSS, GMSK, etc.). However, it may be possible that a type of anomaly may be unknown/new such that the neural network has not been trained to identify such new anomaly. In other words, it may be possible that the anomaly may fall into a ‘none of the above’ category.

In one example and in order to be able to identify such ‘none of the above’ anomaly, a machine learning technique such as autoencoders may be utilized that can compress (using an encoder) and decompress (using a decoder), an input signal received. An encoder may reduce the input signal into smaller dimensions and may then decode it back to the original input dimensions. A difference (error) between the input signal and the output of the decoder can be used as a test of how similar the input signal is to a training data used for training the neural network. If such error or similarly is within a configurable threshold, the output of the trained neural network can indicate that an anomaly exists (and possibly an indication that the anomaly is not one of the specific anomalies on which the neural network has been trained to identify).

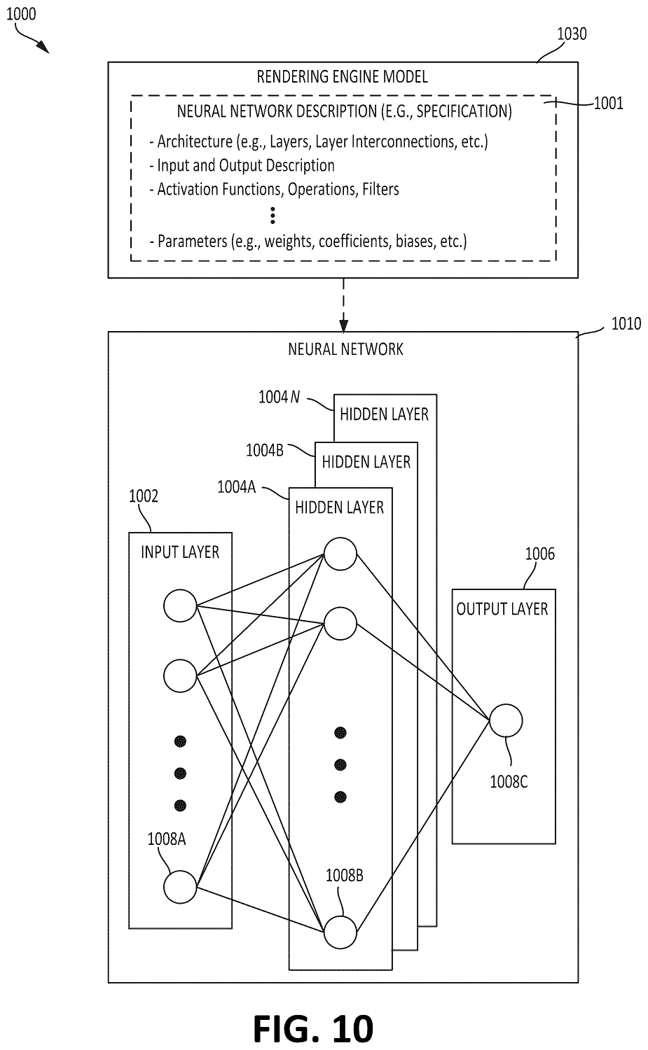

FIG. 10 illustrates an example neural network that can be trained to perform interference signal detection and classification, and/or interference mitigation scheme according to some aspects of the present disclosure.

Architecture 1000 includes a neural network 1010 defined by an example neural network description 1001 in rendering engine model (neural controller) 1030. Neural network description 1001 can include a full specification of neural network 1010. For example, neural network description 1001 can include a description or specification of the architecture of neural network 1010 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

In this example, neural network 1010 can be any of the above-described neural networks trained for signal classification. Neural network 1010 includes an input layer 1002, which can receive input data including, but not limited to, IQ dataset described above, signal features determined for a given signal (e.g., PSD, conjugate CFs, non-conjugate CFs), etc.

Neural network 1010 includes hidden layers 1004A through 1004N (collectively “1004” hereinafter). Hidden layers 1004 can include n number of hidden layers, where n is an integer greater than or equal to one. The number of hidden layers can include as many layers as needed for a desired processing outcome and/or rendering intent. Neural network 1010 further includes an output layer 1006 that provides as output, an identified anomalous signal (co-channel signal) in a cover signal such as DSSS, snuggler, etc. embedded with a DTV signal described above.

Neural network 1010 in this example is a multi-layer neural network of interconnected nodes. Each node can represent a piece of information. Information associated with the nodes is shared among the different layers and each layer retains information as information is processed. In some cases, neural network 1010 can include a feed-forward neural network, in which case there are no feedback connections where outputs of the neural network are fed back into itself. In other cases, neural network 1010 can include a recurrent neural network, which can have loops that allow information to be carried across nodes while reading in input.

Information can be exchanged between nodes through node-to-node interconnections between the various layers. Nodes of input layer 1002 can activate a set of nodes in first hidden layer 1004A. For example, as shown, each of the input nodes of input layer 1002 is connected to each of the nodes of first hidden layer 1004A. The nodes of hidden layer 1004A can transform the information of each input node by applying activation functions to the information. The information derived from the transformation can then be passed to and can activate the nodes of the next hidden layer (e.g., 1004B), which can perform their own designated functions. Example functions include convolutional, up-sampling, data transformation, pooling, and/or any other suitable functions. The output of the hidden layer (e.g., 1004B) can then activate nodes of the next hidden layer (e.g., 1004N), and so on. The output of the last hidden layer can activate one or more nodes of output layer 1006, at which point an output is provided. In some cases, while nodes (e.g., nodes 1008A, 1008B, 1008C) in neural network 1010 are shown as having multiple output lines, a node has a single output and all lines shown as being output from a node represent the same output value.

In some cases, each node or interconnection between nodes can have a weight that is a set of parameters derived from training neural network 1010. For example, an interconnection between nodes can represent a piece of information learned about the interconnected nodes. The interconnection can have a numeric weight that can be tuned (e.g., based on a training dataset), allowing neural network 1010 to be adaptive to inputs and able to learn as more data is processed.

Neural network 1010 can be pre-trained to process the features from the data in the input layer 1002 using the different hidden layers 1004 in order to provide the output through output layer 1006. This training can be performed as described above with reference to stage 206 in FIG. 2. In an example in which neural network 1010 is used to predict usage of the shared band, neural network 1010 can be trained using training data that includes past transmissions and operation in the shared band by the same UEs or UEs of similar systems (e.g., Radar systems, RAN systems, etc.). For instance, past transmission information can be input into neural network 1010, which can be processed by neural network 1010 to generate outputs which can be used to tune one or more aspects of neural network 1010, such as weights, biases, etc.

In some cases, neural network 1010 can adjust weights of nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training media data until the weights of the layers are accurately tuned.

For a first training iteration for neural network 1010, the output can include values that do not give preference to any particular class due to the weights being randomly selected at initialization. For example, if the output is a vector with probabilities that the object includes different product(s) and/or different users, the probability value for each of the different product and/or user may be equal or at least very similar (e.g., for ten possible products or users, each class may have a probability value of 0.1). With the initial weights, neural network 1010 is unable to determine low level features and thus cannot make an accurate determination of what the classification of the object might be. A loss function can be used to analyze errors in the output. Any suitable loss function definition can be used.

The loss (or error) can be high for the first training dataset (e.g., images) since the actual values will be different than the predicted output. The goal of training is to minimize the amount of loss so that the predicted output comports with a target or ideal output. Neural network 1010 can perform a backward pass by determining which inputs (weights) most contributed to the loss of neural network 1010, and can adjust the weights so that the loss decreases and is eventually minimized.

A derivative of the loss with respect to the weights can be computed to determine the weights that contributed most to the loss of neural network 1010. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

Neural network 1010 can include any suitable neural or deep learning network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, neural network 1010 can represent any other neural or deep learning network, such as an autoencoder, a deep belief nets (DBNs), a recurrent neural networks (RNNs), etc.

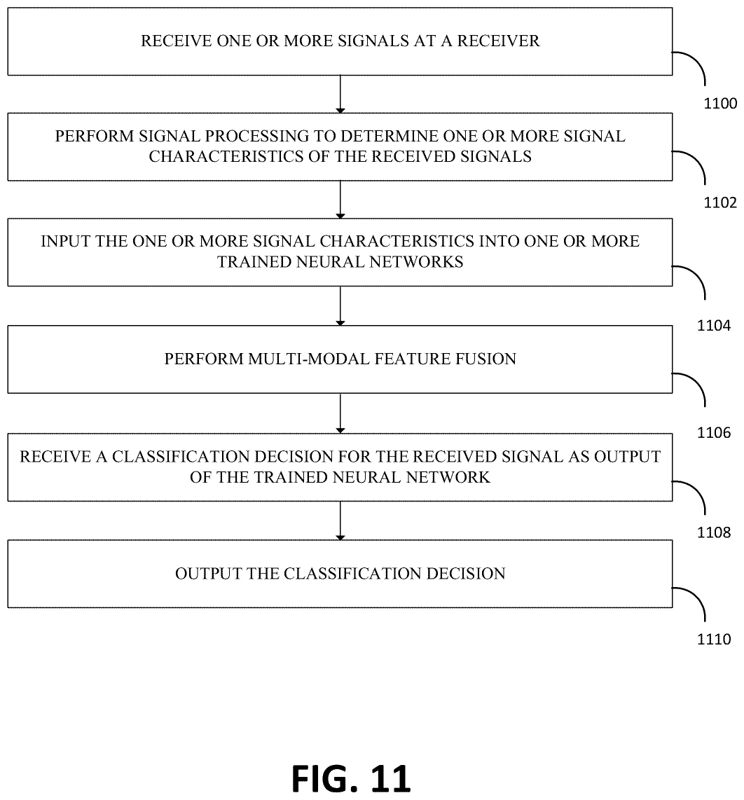

FIG. 11 is an example flowchart of a method of signal classification according to some aspects of the present disclosure. Process of FIG. 11 can be performed by any signal receiver operating in a wireless communication environment including any one of receivers 112 of FIG. 1. Such receiver may have a trained neural network and logics for signal processing in order to implement signal classification as described above. Steps of FIG. 11 will be described from the perspective of a receiver 112 (as a representative of receivers 114, 116, and 118). However, the present disclosure is not limited thereto, and steps of FIG. 11 can be performed by any other network element capable of receiving wireless communication signals that may have co-channel anomalies and unwanted signals embedded therein.

Once a neural network is trained for signal classification, as described above, the following steps may be implemented for real-time reception, processing and classification of co-channel signals.

At step 1100, receiver 112 may receive a signal. The signal may be received at a radio interface of receiver 112. The signal may include a cover signal and an embedded co-channel anomalous signal (e.g., a DSSS, a snuggler, or otherwise an anomaly of unknown type).

At step 1102, receiver 112 may perform signal processing on the received signal to determine one or more signal characteristics to be used as input into a trained neural network for signal classification. The type of signal processing performed on the received signal may be as described above and/or any other known or to be developed signal processing technique that allows for extraction of features that can be used for signal classification and detection of anomalies embedded within a cover signal.

As described above, the one or more signal characteristics can include, but are not limited to, PSD of the signal received at step 1100, conjugate CFs of the signal received at step 110, non-conjugate CFs of the signal received at step 1100, etc.

At step 1104, receiver 112 may provide, as input, the one or more signal characteristics into one or more trained neural networks that has (have) been trained as described above with reference to stage 206 of FIG. 2 and FIGS. 7A-C. In one example, all determined signal characteristics may be provided as input into the trained neural network. In another example, only one or a subset of the determined signal characteristics can be provided as input into the trained neural network model.

At 1106, receiver 112 may perform multi-modal feature fusion to combine the outputs from trained neural networks. Such a multi-modal feature fusion may be carried out using techniques such as feature concatenation or last layer softmax averaging, as described above with reference to FIGS. 7A-C.

At step 1108, the trained neural network model can provide, as output, a classification of the signal received at step 1100. The classification can identify the cover signal (e.g., a DTV signal) and an anomaly (e.g., a DSSS and/or a GMSK, or otherwise an unknown anomaly when an autoencoder described above is utilized).

At step 1110, receiver 112 may output the results of the signal classification. The output may be in any desired format. For instance, the output can be a visual representation of the signal with anomalies identified therein (e.g., similar to visual plot 300 of FIG. 3) or can simply be a text identifying the signal and the anomaly.

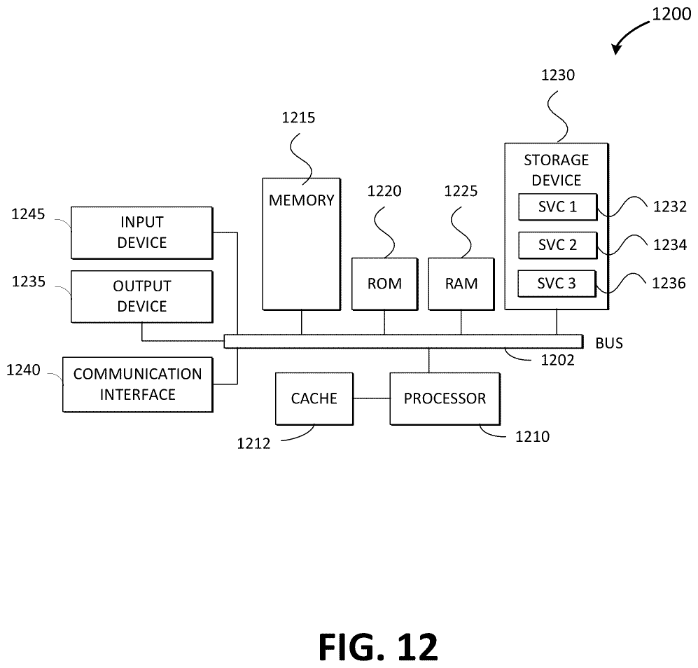

FIG. 12 illustrates an example computing system according to some aspects of the present disclosure. Computing system 1200 can be, for example, any computing device suitable for performing signal classification and detection of co-channel anomalies as described above with reference to FIGS. 1-11, including but not limited to, transmitters 104, receivers 112, etc., and/or any component thereof in which the components of the system are in communication with each other using connection 1202. Connection 1202 can be a physical connection via a bus, or a direct connection into processor 1210, such as in a chipset architecture. Connection 1202 can also be a virtual connection, networked connection, or logical connection.

In some embodiments, computing system 1200 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 1200 includes at least one processing unit (CPU or processor) 1210 and connection 1202 that couples various system components including system memory 1215, read-only memory (ROM) 1220 and random-access memory (RAM) 1225 to processor 1210. Computing system 1200 can include a cache of high-speed memory 1212 connected directly with, in close proximity to, or integrated as part of processor 1210.

Processor 1210 can include any general-purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which can represent any number of input mechanisms, such as a microphone for speech, a touch-sensitive screen for gesture or graphical input, keyboard, mouse, motion input, speech, etc. Computing system 1200 can also include output device 1235, which can be one or more of a number of output mechanisms known to those of skill in the art. In some instances, multimodal systems can enable a user to provide multiple types of input/output to communicate with computing system 1200. Computing system 1200 can include communication interface 1240, which can generally govern and manage the user input and system output. There is no restriction on operating on any particular hardware arrangement, and therefore the basic features here may easily be substituted for improved hardware or firmware arrangements as they are developed.

Storage device 1230 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1230 can include software services, servers, services, etc., that when the code that defines such software is executed by the processor 1210, it causes the system to perform a function. In some embodiments, a hardware service that performs a particular function can include the software component stored in a computer-readable medium in connection with the necessary hardware components, such as processor 1210, connection 1202, output device 1235, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in Memory of a client device and/or one or more servers of a content management system and perform one or more functions when a Processor executes the software associated with the service. In some embodiments, a service is a program or a collection of programs that carry out a specific function. In some embodiments, a service can be considered a server. The Memory can be a non-transitory computer-readable medium.

In some embodiments, the computer-readable storage devices, mediums, and Memories can include a cable or wireless signal containing a bit stream and the like. However, when mentioned, non-transitory computer-readable storage media expressly exclude media such as energy, carrier Signals, electromagnetic waves, and Signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state Memory devices, flash Memory, USB devices provided with non-volatile Memory, networked storage device(s), and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Claim language or other language reciting “at least one of” a set and/or “one or more” of a set indicates that one member of the set or multiple members of the set (in any combination) satisfy the claim.

For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A method comprising:
receiving, at a receiver, a signal, the signal including a cover signal and an embedded co-channel anomalous signal;
performing, at the receiver, signal processing on the signal to determine one or more characteristics of the signal;
inputting, at the receiver, the one or more characteristics into one or more trained neural networks;
and
receiving, as an output of the trained neural network, a classification of the signal, the classification identifying the cover signal and the embedded co-channel anomalous signal.

2. The method of claim 1, wherein the one or more signal characteristics include a power spectral density of the signal, conjugate cycle frequencies of the signal, and non-conjugate cycle frequencies of the signal.

3. The method of claim 1, wherein at least one of the one or more characteristics is inputted into the trained neural network.

4. The method of claim 1, further comprising:
performing multimodal fusion to combine outputs of at least two of the trained neural networks to determine the output.

5. The method of claim 1, wherein the cover signal is one of a Long-Term Evolution (LIE), 3GPP 5G signals, Wi-Fi, Digital Video Broadcasting (DVB) or Advanced Television Systems Committee-Digital Television (ATSC-DTV) signals.

6. The method of claim 1, wherein the co-channel anomalous signal is one of a one of a Direct Sequence Spread Spectrum (DSSS) signal, a Single Carrier Signal using Binary Phase Shift Keying (BPSK), a Quadrature Phase Shift Keying (QPSK), a Quadrature Amplitude Shift Keying (QAM), Amplitude Phase Shift Keying (APSK) modulations, Chirp Modulated signal, a Frequency Modulated (FM) signal, a Frequency Shift Keying (FSK) signal, an Orthogonal Frequency Division Multiplexing (OFDM) signal, a Bursty signal, a Frequency Hopping Spread Spectrum Signal (FHSS), or a Gaussian Minimum Shift Keying (GMSK) signal.

7. The method of claim 1, wherein the trained neural network is trained using a combination of over-the-air captured signals injected with synthetic co-channel anomalous signals.

8. A wireless network receiver comprising:
one or more memories including computer-readable instructions; and
one or more processors configured to execute the computer-readable instructions to:
receive a signal, the signal including a cover signal and an embedded co-channel anomalous signal;
perform signal processing on the signal to determine one or more characteristics of the signal;
input the one or more characteristics into a trained neural network; and
receive, as an output of the trained neural network, a classification of the signal, the classification identifying the cover signal and the embedded co-channel anomalous signal.

9. The wireless network receiver of claim 8, wherein the one or more signal characteristics include a power spectral density of the signal, conjugate cycle frequencies of the signal, and non-conjugate cycle frequencies of the signal.

10. The wireless network receiver of claim 8, wherein at least one of the one or more characteristics is inputted into the trained neural network.

11. The wireless network receiver of claim 8, wherein the one or more processors are further configured to perform multimodal fusion to combine outputs of at least two of the trained neural networks to determine the output.

12. The method of claim 8, wherein the cover signal is one of a Long-Term Evolution (LIE), 3GPP 5G signals, Wi-Fi, Digital Video Broadcasting (DVB) or Advanced Television Systems Committee-Digital Television (ATSC-DTV) signals.

13. The wireless network receiver of claim 8, wherein the co-channel anomalous signal is one of a Direct Sequence Spread Spectrum (DS S S) signal, a Single Carrier Signal using Binary Phase Shift Keying (BPSK), a Quadrature Phase Shift Keying (QPSK), a Quadrature Amplitude Shift Keying (QAM), Amplitude Phase Shift Keying (APSK) modulations, Chirp Modulated signal, a Frequency Modulated (FM) signal, a Frequency Shift Keying (FSK) signal, an Orthogonal Frequency Division Multiplexing (OFDM) signal, a Bursty signal, a Frequency Hopping Spread Spectrum Signal (FHSS), or a Gaussian Minimum Shift Keying (GMSK) signal.

14. The wireless network receiver of claim 8, wherein the trained neural network is trained using a combination of over-the-air captured signals injected with synthetic co-channel anomalous signals.

15. One or more non-transitory computer-readable media comprising computer-readable instructions, which when executed by one or more processors of a wireless network receiver, cause the wireless network receiver to:
receive a signal, the signal including a cover signal and an embedded co-channel anomalous signal;
perform signal processing on the signal to determine one or more characteristics of the signal;
input the one or more characteristics into a trained neural network; and
receive, as an output of the trained neural network, a classification of the signal, the classification identifying the cover signal and the embedded co-channel anomalous signal.

16. The one or more non-transitory computer-readable media of claim 15, wherein the one or more signal characteristics include a power spectral density of the signal, conjugate cycle frequencies of the signal, and non-conjugate cycle frequencies of the signal.

17. The one or more non-transitory computer-readable media of claim 15, wherein the execution of the computer-readable instructions by the one or more processors further causes the wireless network receiver to perform multimodal fusion to combine outputs of at least two of the trained neural networks to determine the output.

18. The one or more non-transitory computer-readable media of claim 15, wherein the cover signal is one of a Long-Term Evolution (LTE), 3GPP 5G signals, Wi-Fi, Digital Video Broadcasting (DVB) or Advanced Television Systems Committee-Digital Television (ATSC-DTV) signals

19. The one or more non-transitory computer-readable media of claim 15, wherein the co-channel anomalous signal is one of a Direct Sequence Spread Spectrum (DSSS) signal, a Single Carrier Signal using Binary Phase Shift Keying (BPSK), a Quadrature Phase Shift Keying (QPSK), a Quadrature Amplitude Shift Keying (QAM), Amplitude Phase Shift Keying (APSK) modulations, Chirp Modulated signal, a Frequency Modulated (FM) signal, a Frequency Shift Keying (FSK) signal, an Orthogonal Frequency Division Multiplexing (OFDM) signal, a Bursty signal, a Frequency Hopping Spread Spectrum Signal (FHSS), or a Gaussian Minimum Shift Keying (GMSK) signal.

20. The one or more non-transitory computer-readable media of claim 15, wherein the trained neural network is trained using a combination of over-the-air captured signals injected with synthetic co-channel anomalous signals.
